(19) United States
(12) Patent Application Publication
(10) Pub. No.: US 2024/0109623 A1
(43) Pub. Date: Apr. 4, 2024

(54) WATER SPORTS BOARD STRUCTURE AND A METHOD FOR MAKING THE SAME

(71) Applicant: ITALIANWAVES S.R.L., Alghero, Sassari (IT)

(72) Inventors: Alessandro DANESE, Cagliari (IT); Michele PIGA, Olmedo (IT)

(73) Assignee: ITALIANWAVES S.R.L., Alghero, Sassari (IT)

(21) Appl. No.: 18/275,392

(22) PCT Filed: Feb. 2, 2022
(86) PCT No.: PCT/IB2022/050923

§ 371 Date: Aug. 1, 2023

(30) Foreign Application Priority Data
Feb. 2, 2021 (IT) 102021000002261

(51) Int. Cl. B63B 32/57; B32B 3/04; B32B 5/02; B32B 5/18; B32B 5/24; B32B 9/02; B32B 9/04; B32B 27/12; B32B 37/06; B32B 37/10; B32B 37/24; B32B 38/08; B63B 73/50

(52) U.S. Cl. CPC B63B 32/57; B32B 3/04; B32B 5/02; B32B 5/18; B32B 5/245; B32B 9/02; B32B 9/046; B32B 9/047; B32B 27/12; B32B 37/06; B32B 37/10; B32B 37/24; B32B 38/08; B63B 73/50; B32B 2037/243; B32B 2255/10; B32B 2255/26; B32B 2260/021; B32B 2260/046; B32B 2262/10; B32B 2266/0264; B32B 2305/022; B32B 2305/073; B32B 2307/7376; B32B 2309/02; B32B 2315/00; B32B 2317/02; B32B 2367/00; B63B 2231/50

(57) ABSTRACT

In a water sports board structure (3), a composite material shell (20) encloses a core (10) including a shaped body (11) made of a foam material obtained by a mixture of polylactic acid, preferably between 60% and 80% by weight, and of a polymer selected between an aliphatic polyester and an aliphatic/aromatic co-polyester. For the foam material, a biodegradable Ecovio EA material is preferably used, in particular Ecovio® EA200 or ECOVIO® 80EA2394EXP. In an exemplary embodiment, the shaped body (11) incorporates at least one, or preferably two cork longitudinal stringers (13) spaced apart from each other by about half the cross width of the core (10). The shell (20) can comprise a fibre layer (21,24), preferably of basalt fibres, impregnating with a resin, which can optionally form a resin layer (23,26) outside the fibre layers (21,24). A further resin-impregnated fabric layer (22) can be present between the core (10) and the fibre layer (21) of the shell (20). The above foam materials allow manufacturing boards that are at least 20% lighter than the conventional boards including polystyrene foam cores, and that have suitable elasticity while having excellent impact strength and/or resistance to abrasion, such a combination leading to high-performance water sports boards. Moreover, polylactic acid as well as the above aliphatic polyesters or aliphatic/aromatic co-polyesters are fully biodegradable, which allows environment-friendly disposal of the water sport boards of the invention, for instance, by composting, without forming any special waste.

### FIELD OF THE INVENTION

The present invention relates to a water sports board structure such as a surf board, a bodyboard, a windsurf board, a stand-up paddle board, a wake surf board, a wakeboard, a kitesurf board, a skim board, a soft-top board and the like. In the following description, such expressions as “board”, “water sports board” or “surf board” relate to any of the above-mentioned boards and the like.

### REFERENCES TO THE PRIOR ART—TECHNICAL PROBLEM

As known, the water sports boards must be able to support a user's weight, while allowing him/her to float on the water surface. Moreover, the water sports boards must have suitable impact toughness properties, while having an excellent damping capacity. A hydrodynamic shape is also required depending on the sports specialty or specialties for which they are intended.

The structure of water sports boards comprises a core portion providing the required mechanical strength. For the reasons explained above, the core portion must be light, i.e., a low-density material must be used for its manufacture. Normally, expanded materials such as polystyrene or polyurethane are used. However, these materials usually have a poor impact strength and/or resistance to abrasion. For this reason, in order to obtain an impact and wear resistant water sports board, a protective coating is in most cases provided on the core, normally consisting of glass or carbon fibre layers impregnated with a resin that is caused to cross-link once the fibres have been laid on the core, for instance, as described in FR2787088. In that case, the core is coated with carbon fibres impregnated with an epoxy resin, and the resulting layer is then flattened in a vacuum bag, and subsequently smoothed. Finally, the shell covering the core portion is painted with a polyurethane paint.

Such a structure makes it possible to obtain a remarkable mechanical strength and good performance properties, which is however desirable to improve.

Water sports boards are also known including a core made of cork and polystyrene, as described, for instance, in U.S. Pat. No. 9,045,201 B1, which describes a method for making surfboards comprising alternate layering of cork and a material other than cork, so as to obtain a multilayer structure that is finally consolidated under vacuum.

In other cases, as described, for instance, in US2009264034A1, longitudinal members or stringers are embedded in the foam material of the board, in order to increase the breaking strength and the capacity to absorb shocks. In particular, two expanded polyurethane moulded halves are provided enclosing a longitudinal central carbon fibre stringer.

Another drawback of the above-mentioned water sports boards is that the core polymeric material is not biodegradable, which leads to high disposal costs and/or pollution issues. For this reason, significant costs arise to dispose of such water sports boards without risk of environmental contamination.

Therefore, the need is felt of a water sports board made of a material that is biodegradable enough to allow environment-friendly disposal of the boards once they have been dismissed, for instance, by composting. US2020239670, describes a water sports board including a biodegradable core made of expanded acetylated chitin, and an easily removable fiberglass shell enclosing it, thus allowing recovery and disposal by biodegradation of the core when dismissing the board.

US2012196079 discloses a sports board made of a composite body having a two layer laminate coating surrounding a core and impermeable to air and to water. A positive pressure is present at least in a portion of the core, which is made of an open-cell foam which permits air to be entrapped within the shell. The positive pressure is applied through a valve anc can range between 0.5 and 5 bar, achieving a higher resistance comparable to heavier foams like EPS.

### SUMMARY OF THE INVENTION

It is therefore a feature of the present invention to provide a water sports board structure that can be disposed, at the end of its useful life, more environment friendly than the board structures known so far.

It is also a feature of the present invention to provide such a water sports board structure that has elastic and strength properties, in particular shock absorption properties, comparable to or better than the board structures known so far known so far, in particular a structure is desired comprising a highly impact-resistant, very light shell steadily fixed the core.

It is another feature of the present invention to provide such a water sports board structure that is at the same time at least as light as or even lighter than the board structures known so far known so far.

These and other objects are achieved by a method for making a water sports board having a predetermined board shape, and by a water sport board structure having a predetermined board shape, as defined by claims 1 and 18, respectively. Advantageous modifications of the method and specific embodiments of the water sports board structure are defined by respectively dependent claims.

According to an aspect of the invention, the method comprises the steps of:
forming a core including a shaped body in a foam material, comprising, as main components comprising the following components:
   polylactic acid, preferably obtained by polymerization of lactic acid formed by fermentation of destructured starch, and
   a polymer selected from the group comprised of an aliphatic polyester, an aliphatic/aromatic co-polyester, a combination thereof;
externally covering the core by a protective shell of a composite material, wherein the step of forming the core comprises the steps of:
providing a semi-finished product selected between:
   a pre-formed semifinished product of the foam material, the pre-formed semifinished product having a preliminary shape, and
   a parallelepiped semi-finished product of the foam material, the parallelepiped semifinished product having the form of a parallelepiped block;
forming the semi-finished product into the shaped body, by hand working or machining, the step of forming including turning the preliminary shape or the parallelepiped shape into the shaped body shape.

According to another aspect of the invention, the water sports board structure comprises a core and a shell or coating of a composite material that externally covers the core, wherein the core comprises a shaped body made of a foam material comprising, as main components:
polylactic acid, preferably obtained by polymerization of lactic acid formed by fermentation of destructured starch, and
a polymer selected from the group comprised of an aliphatic polyester, an aliphatic/aromatic co-polyester, a combination thereof,
   wherein the core is formed from a semi-finished product selected between:
a pre-formed semifinished product having a preliminary shape, and
a parallelepiped semi-finished product having the form of a parallelepiped block;
   by hand working or machining, so as to turn the preliminary shape or the parallelepiped shape into the board shape.

Polylactic acid, in combination with the aliphatic polyesters or the aliphatic/aromatic co-polyesters, forms a very easily biodegradable material of which the core of the board is manufactured. Moreover, the core is hermetically and preferably also optically sealed by the shell. Therefore, the core does not degrade during the useful life of the board due to exposition to the environment, in particular to water and possibly light. When the board has to be dismissed, the shell can be easily removed from the core, and the latter can therefore be disposed by degradation, i.e. by a fully environment-friendly process in which no special waste is formed. For instance, the core can be disposed by composting, which also produces a useful effect besides eliminating a waste material.

Moreover, a board is obtained that can be lighter by up to 20% than corresponding boards including cores made of polystyrene foam, and that has remarkable impact strength properties to resist to the forces that are normally involved during the use of the water sports board. A further advantage is that the pre-formed semifinished product of the foam material or parallelepiped semi-finished product can be made by small parts connected by heat to each other without the use of glue, as also indicated in examples below. The absence of glue permits to obtain a very eco-friendly core even in case the core is made by several parts connected together.

Briefly, the invention makes it possible to obtain highly-performant water sports boards due to an unusual combination of impact strength and lightness, in which, furthermore, at least the core portion can be easily and environment-friendly disposed, for instance by composting, due to the biodegradability of the components of the core itself.

Advantageously, the polylactic acid is present by an amount set between 60% and 80% by weight, preferably about 75% by weight of the polymer component including an aliphatic polyester or an aliphatic/aromatic co-polyester, so as to be easily and optimally expanded. Preferably, the foam material is a polymer blend selected among the polymer blends commercially known as Ecovio EA, most preferably it is selected between the polymer blends commercially known as Ecovio EA200 or ECOVIO 80EA2394EXP. These materials have shown an optimum combination of such properties as lightness, elasticity and mechanical strength, besides being fully biodegradable.

In a preferred exemplary embodiment, the shaped body of the core incorporates at least one cork longitudinal stringer, preferably, two cork longitudinal stringers spaced apart from each other by about half the cross width of the core. The presence of the cork stringer or of the cork stringers maximizes the elasticity and the impact strength of the board. Accordingly, the step of forming the core can include a step of incorporating at least one cork longitudinal stringer, preferably, two cork longitudinal stringers spaced apart as described above, for instance, by laterally gluing two cork longitudinal elements of the pre-formed semifinished product to a central foam material element of the pre-formed semifinished product and to respective side foam material longitudinal elements of the pre-formed semifinished product, wherein the central foam material element, the side foam material longitudinal elements and the side foam material longitudinal elements are turned into a central foam material portion, side foam material longitudinal portions and side foam material longitudinal portions of the shaped body when then the semifinished product is formed into the shaped body by removing material, i.e. by machining or hand working. Alternatively, the at least one cork longitudinal stringer or two cork longitudinal stringers can be arranged in respective longitudinal grooves machined in the shaped body of the core.

In a preferred exemplary embodiment, the shell comprises a fibre layer and a resin impregnating the fibre layer. In particular, a portion of the resin forms a resin layer outside of the fibre layer. Accordingly, the step of externally covering the core includes steps of covering the core by a fibre layer and impregnating the fibre layer by a resin, before or after the step of covering the core by a fibre layer, optionally in such a way that a portion of the resin forms the resin layer outside of the fibre layer. Preferably, the fibre layer comprises basalt fibres. Basalt fibres improve such properties of the shell as opacity, to extend the useful life of the core and of the board itself. However, glass fibres can be also used.

Preferably, the fibres layer and possibly the resin layer are mirror-like arranged on both faces of the core.

In an exemplary embodiment, the shell comprises a further fabric layer impregnated by the resin between the core the fibre layer. Accordingly, the step of externally covering the core by a shell can include a step of covering the core by a further fabric layer and impregnating the further fabric layer with the resin before the step of covering the core by a first fibre layer. Preferably, an outer layer of a protective paint is provided, in particular a polyurethane protective paint.

In a preferred embodiment, the core is formed by a plurality of core elements arranged upon and/or beside one another and thermally connected to one another at respective mutual interfaces. Accordingly, in a corresponding preferred modification of the method, the step of providing a semi-finished product includes:
providing a plurality of core elements of the foam material;
connecting the core elements with one another onto and/or beside one another, until the preliminary or parallelepiped shape of the pre-formed or parallelepiped semifinished product, respectively, is obtained;
wherein the step of connecting the core elements comprises the steps of:
   locally heating the core elements at respective mutual contact interfaces up to a predetermined connection temperature, preferably lower than or at most equal to 80° C., and
   pressing against one another the core elements arranged upon or beside one another until the core elements are connected together by thermal and pressure effect only, forming the semi-finished product.

Preferably, the core elements to be connected beside and upon one another are rectangular tile-shaped core elements, i.e., parallelepiped core elements having an elementary height, i.e., a thickness t shorter than the other dimensions.

These modifications of the method, and the corresponding embodiments of the water sports board of the invention produces several useful technical effects.

Firstly, the technique of connecting core elements generates less waste materials at the time of cutting of finishing the semi-finished product into the shaped body, or directly into the core.

Moreover, if rectangular tile-shaped core elements of the same size are used to make the semifinished product, similar elementary moulds, i.e. the ones where the tile-shaped core elements are made by turning the core polymer components into the foam material, can economically be used regardless the size and the shape of the boards to be manufactured.

Moreover, if the rectangular tile-shaped core elements are used to make a parallelepiped semifinished product, a same final mould, i.e., the one where the core elements are connected to make the semifinished product, can economically be used regardless the size of the board to be manufactured.

Moreover, the core element made according to the invention can be surprisingly connected to one another to form a same block by thermal and pressure effect only, which makes it possible to avoid the use of such materials as glues, most of which are hardly biodegradable or not biodegradable at all. Therefore, the core obtained by connecting core elements this way can be disposed in the same way as cores obtained form a single block, without additional issues, while exploiting the above-mentioned advantages of the way to form the semifinished product by core element connection.

Preferably, the step of locally heating the core elements is carried out by directing to the contact interfaces a warm laminar air flow at a temperature set between 70° C. and 90° C., in particular, before said step of pressing the core elements against one another.

The method according to claim 13, wherein the core elements have an elementary thickness of at most 30 mm, in particular of at most 25 mm, and the semi-finished product has an overall thickness set between 100 and 200 mm.

The method according to claim 13, wherein the core elements have the shape of rectangular tiles having the elementary thickness.

### BRIEF DESCRIPTION OF THE DRAWINGS

The invention will be now shown with the description of some exemplary embodiments, exemplifying but not limitative, with reference to the attached drawings, in which the same reference characters designate the same or similar parts, throughout the figures, of which:

FIG. 1 is an exploded perspective view of a water sport board according to an exemplary embodiment of the invention, in which the core comprises a body made of a single material;

FIG. 2 is a cross-sectional view of the board of FIG. 1;

FIG. 3 is a top plan view of a pre-formed semi-finished product from which a shaped body of the core for the water sports board is obtained according to the invention;

FIG. 4 is a cross-sectional view of the board of FIG. 3;

FIG. 5 is a top plan view of a parallelepiped semi-finished product from which a shaped body of the core for the water sports board is obtained according to the method of invention;

FIG. 6 is a cross-sectional view of the board of FIG. 5;

FIG. 7 is an exploded perspective view of a water sport board according to another exemplary embodiment of the invention, in which the coating is a multi-layer coating;

FIG. 8 is a cross-sectional view of the board of FIG. 7;

FIG. 9 is an exploded perspective view of a board according to a further exemplary embodiment of the invention, in which the core comprises longitudinal stringers, typically made of cork;

FIG. 10 is a cross-sectional view of the board of FIG. 9;

FIGS. 11 and 12 are cross-sectional views of parallelepiped semi-finished products from which shaped bodies of cores for water sports boards are obtained according to some modifications of the method of the invention, in which the cross-sectional view hatched pattern is omitted for the sake of clarity.

### DESCRIPTION OF PREFERRED EXEMPLARY EMBODIMENTS

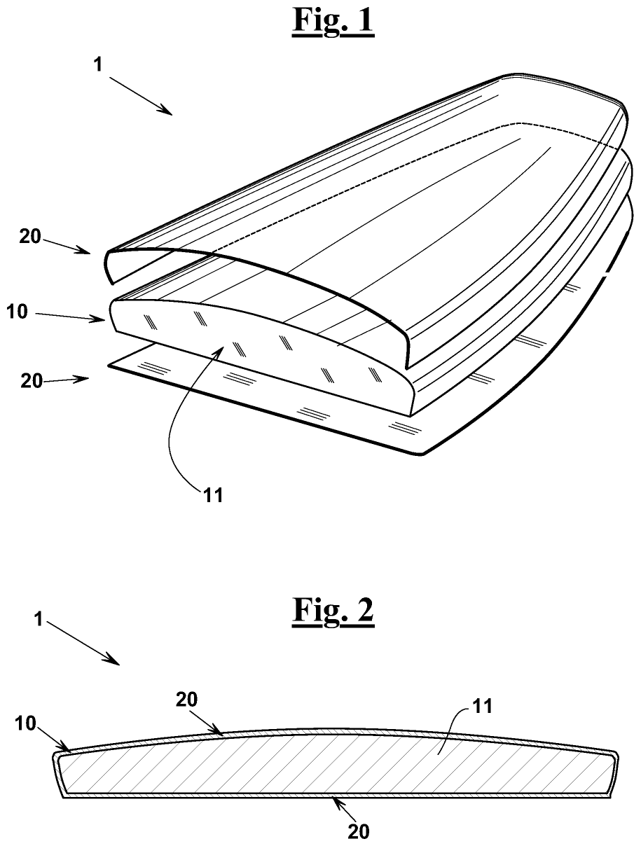

With reference to FIGS. 1 and 2, a water sports board structure 1 is described according to an exemplary embodiment of the invention. Water sports board structure 1 has a predetermined board shape and includes a core and a shell 20 externally covering and enclosing, i.e. sealing, core 10.

Core 10 comprises a shaped body 11 made of a foam material. Shaped body 11 is provided as a pre-formed semi-finished product, or as a semi-finished product having the shape of a parallelepiped block to be subsequently hand-worked or preferably machined, in particular, by a computer numerical control machine, in order to obtain a predetermined shape suitable for making a water sports board, as known by a person skilled in the art of manufacturing water sports boards.

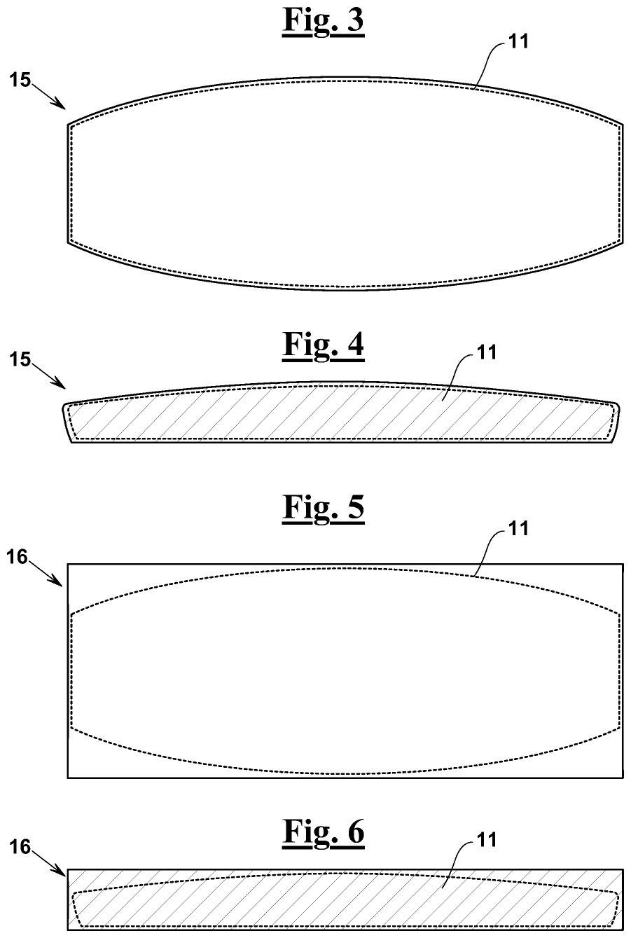

A pre-formed semi-finished product 15 having a preliminary shape and a parallelepiped semi-finished product 16 are exemplary shown in FIGS. 3,4 and in FIGS. 5,6, respectively, along with respective shaped bodies 11 formed therefrom by a hand working or machining forming step. In both cases shaped body 11 is shown by a dotted line. The preliminary shape of semi-finished product is similar to the shape that shaped body 11 must have, which is in turn similar or substantially the same shape as the board shape of water sports board structure 1, apart from the shell 20, which only slightly increases the size of board 1 with respect to core 10, without substantially changing the outline of core 10 and of shaped body 11.

In some instances, pre-formed semi-finished product 15 can be turned into shaped body 11 by removing very small amount of foam material, possibly even by finishing only, thus minimizing the waste of such material. This may be accomplished both manually and mechanically, for instance, by milling under the assistance of a computer numerical control machine.

Semi-finished product 16 can be turned into shaped body 11 by a cutting operation, preferably by a computer numerical control machine. The possibility to use a same mould to make shaped bodies of different sized and shapes can balance the higher waste of material of this solution.

The foam material of the semi-finished product from which the core is manufactured is obtained by expanding an expandible polymer material in a mould at a predetermined temperature or following a predetermined temperature cycle, possibly adding an expanding agent, as it is well known by a person skilled in the art of manufacturing water sports boards, and therefore not described more in detail.

In a non-limiting embodiment, core 10, and therefore shaped body 11 has a convex first face 10a and a second face 10b that is flat or less convex than first face 10a. Convex first face 10a is conceived as the upper face, i.e. as the face on which the user will stand when using board 1. In any case, the shape of board 1 is not described more in detail since it is known by a person skilled in the art of manufacturing water sports boards.

According to the invention, the expandible material, starting from which the semi-finished product is formed, and therefore the foam material of sheet 11, includes a mixture of polylactic acid and of a polymer that can be an aliphatic polyester or an aliphatic/aromatic co-polyester or a combination thereof. The polylactic acid present in the mixture is preferably obtained by polymerizing lactic acid, which is in turn obtained by fermentation of destructured starch.

Accordingly, after the step of coating, and further steps described hereinafter, a board 1 is obtained having enhanced mechanical properties and excellent performances, as exemplified hereinafter. Moreover, board 1 at most contains a very small amount of a non-biodegradable material, substantially only in the conventional shell or coating 20, as described hereinafter.

In fact, polylactic acid, as well as the aliphatic polyesters or the aliphatic/aromatic co-polyesters, from which shaped body 11 or core 10 of the board is manufactured, are easily biodegradable materials. Since the core 10 is hermetically and preferably also optically sealed by the shell 20, core 10 does not degrade during the useful life of the board due to exposition to the environment, in particular to water and possibly light.

This way, in order to dispose such a board, if irreparably damaged or for other reasons, shell 20 is separated from core 10 and is conventionally disposed, while remaining shaped body 11 of core 10 that can be composted or in any case environment-friendly disposed.

Moreover, the board including core 10 can be lighter by up to 20% than corresponding boards including cores made of polystyrene foam, and that has remarkable impact strength properties to resist to the forces that are normally involved during the use of the water sports board.

A further advantage is that the shaped body 11 of core 10 can be made by small parts of the claimed expanded material connected by heat to each other without the use of glue, as also indicated in examples below. The absence of glue permits to obtain a very eco-friendly core even in case the core is made by several parts connected together.

In particular, the foam material is a polymer blend selected among the polymer blends manufactured by BASF and known as Ecovio EA, more in particular, the foam material can be selected between Ecovio EA200 blend, or ECOVIO 80EA2394EXP blend. Boards made of these materials and maintained during 12 to 48 days under conventional ageing conditions, had the properties summarized in Table 1. The grain size of polymer blend particles used to make shaped body 11 was set between 1.0 and 1.2 mm.

TABLE 1

| | Units of | |
|---|---|---|
| Property | measurement | Values |
| True density of core material | kg/m³ | 28-35 |
| Apparent density of foam material | kg/m³ | 30-45 |
| Crash ratio | — | 2.7 |
| Compression strength 30 kg/m³ @ 10% | kPa | 125 |
| Flexural fracture energy | J | 2.7 |
| Bending strength | kPa | 220 |

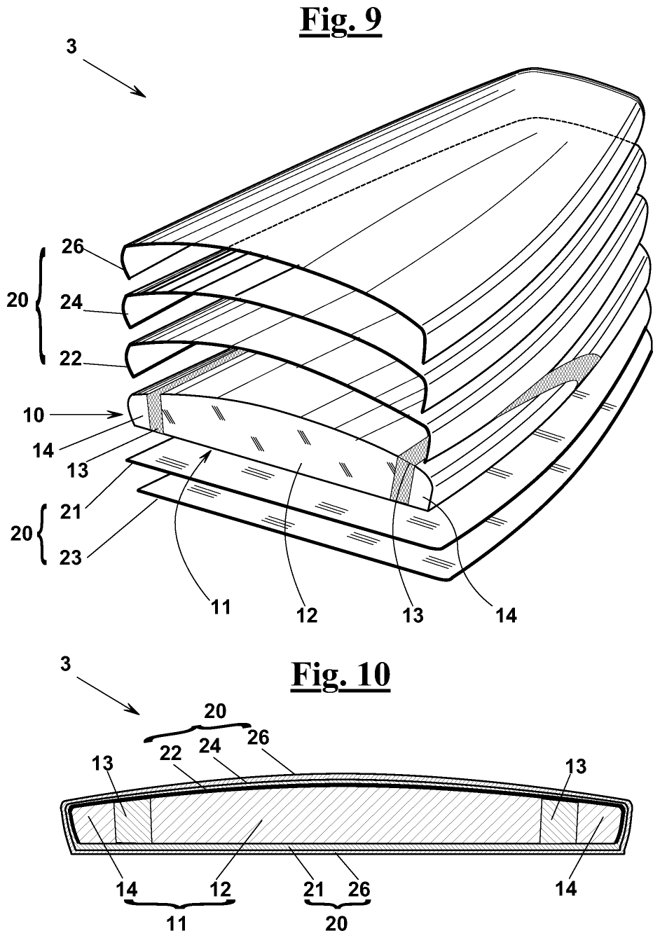

In the preferred exemplary embodiment of FIGS. 9 and 10, shaped body 11 comprises a plurality of longitudinal elements 12, 13, 14 arranged adjacent to each other. Longitudinal element 12 and two longitudinal elements 14 are central element and two side elements, respectively, made of the foam material described above, while longitudinal elements 13 arranged between central element 12 and respective side elements 14, are preferably made of cork. This structure can be obtained by machining or hand-working a similarly structured semi-finished product as described above. Longitudinal elements 12, 13, 14 can be connected to one another by conventional techniques, for instance by gluing them together, and then forming the obtained structure to the final shape by milling and smoothing processes.

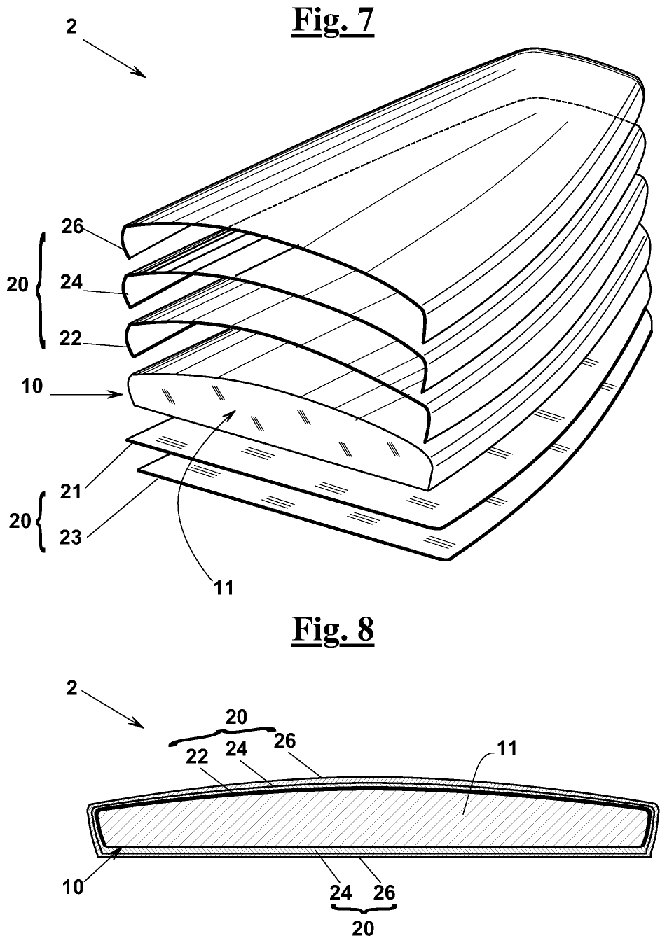

As shown in FIGS. 7-10, shell 20 can comprise a plurality of layers 21, 22, 23, 24, 26. More in detail, these layers can include a fibre layer 21, 24 arranged on opposite faces of core 10, and resin layers 23, 26, preferably including an epoxy resin, arranged on fibre layers 21 and 24. More in detail, the fibre layers are impregnated with an epoxy resin applied in such a way to cover the fibre layer itself and to form external resin layers 23, 26. In particular, a bio-based epoxy resin can be used, so as to increase biodegradability of the board.

In particular, the application of the resin is performed by adding a curing agent, also referred to as a catalyst, to a base resin, and then arranging the catalysed resin on fibre layers 21 and 24, for example, by manually smearing the resin onto the fibres, also obtaining also external resin layers 23, 26, and waiting for the cross-linking reaction of the resin to be completed. This step can also comprise a conventional heat treatment including a suitable temperature cycle, up to a predetermined cross-linking temperature of the semi-finished product comprising core 10 and shell 20 being made. The resin layer and the fibre layers or layers can be flattened by a conventional vacuum treatment that is not described in detail, since it is well known by a person skilled in the art. In particular, the cross-linking reaction can be performed while maintaining the semi-finished product under vacuum, for example within a vacuum bag, in order to remove residual air from the resin and the fibre layers.

Fibre layers 21, 24 can include glass fibre, carbon fibre, aramid fibre or, preferably, basalt fibre.

In particular, the fibre layer can include a textured mat of basalt fibres, in particular, having a specific density set between 100 and 150 g/m².

In an exemplary embodiment, a further fibre layer 22 can be provided between core 10 and fibre layers 21, 24, including an epoxy resin impregnated fabric, for example a basalt fibre fabric, or even a honeycomb structure, impregnated which are also of epoxy resin. In particular, the layer in impregnated fibre 22 is arranged between core 10 and upper fibre layer 24, i.e. the fibre layer of shell coating 20 on the side of the board for supporting the user.

FIGS. 9 and 10 show shell 20 consisting of the plurality of layers 21, 22, 23, 24, 26, in addition to stringers 13. However, stringers 13 can be provided even if such a layer structure of shell 20 is not present, for instance, if only a basic mono-layer structure is provided as in FIGS. 1 and 2. Stringers 13 can also be arranged and fixed in longitudinal grooves (not shown) made in core 10.

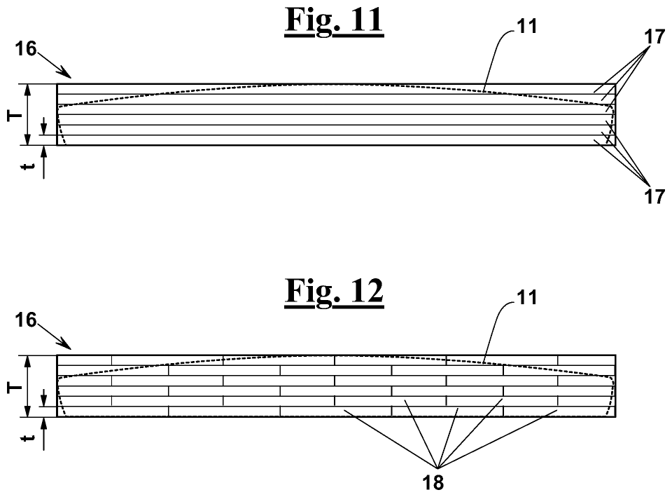

FIGS. 11 and 12 show parallelepiped semi-finished product 16 made according two different exemplary embodiments of the method, exploiting the property of the claimed material that permits shaped body 11 of core 10 to be made by small parts connected by heat to each other without the use of glue, in order to obtain a very eco-friendly core even in case the core is made by several parts connected together.

As shown in FIGS. 11 and 12 steps are provided of providing a plurality of core elements 17, 18 of the claimed foam material, and of connecting core elements 17, 18 with one another by surface heating. The outline of desired shaped body 11 is also shown in dotted lines. Preferably, core elements 17 and 18 have an elementary thickness t not exceeding 30 mm, most preferably not exceeding 25 mm, and the semi-finished product 16 has an overall thickness T set between 100 and 200 mm. Therefore, four to eight-nine layers of core elements 18 are normally required to obtain the desired overall thickness T of semi-finished product 16 in order to make a water sports board according to the invention.

More in detail, core elements 17 of FIG. 11 are sheets of the foam material arranged upon one another, while core elements 18 of FIG. 12 are preferably rectangular tile-shaped core elements, i.e., parallelepiped core elements having an elementary height, i.e., a thickness t shorter than the other dimensions. Tile-shaped core elements 18 are arranged upon and/or beside one another.

The step of connecting core elements 17, 18 includes locally heating core elements 17, 18 at respective mutual contact interfaces up to a predetermined connection temperature, preferably not exceeding 80° C. and pressing core elements 17, 18 against one another until the core elements 17, 18 become connected to one another. The connection to form the semi-finished product 16 in therefore performed by heat and pressure effect only.

The method according to claim 13, wherein the step of locally heating the core elements is carried out by directing to the contact interfaces a warm laminar air flow at a temperature set between 70° C. and 90° C.

Obviously, the same applies for a pre-formed semi-finished product 15 of FIGS. 3 and 4.

As also said above, the technique of making a core by connecting core elements 17 or 18 to each other generates less waste materials at the time of cutting of finishing the semi-finished product into the shaped body, or directly into the core. Moreover, if rectangular tile-shaped core elements 18 of the same size are used to make the semifinished product, similar elementary moulds, i.e. the ones where the tile-shaped core elements are made by turning the core polymer components into the foam material, can economically be used regardless the size and the shape of the boards to be manufactured.

The foregoing description of exemplary embodiments of the invention will so fully reveal the invention according to the conceptual point of view, so that others, by applying current knowledge, will be able to modify and/or adapt such embodiment for various application, without further research and without parting from the invention, and, accordingly, it is meant that such modifications and adaptations will have to be considered as equivalent to the described exemplary embodiments. The means and the materials to put into practice the different functions described herein could have a different nature without, for this reason, departing from the field of the invention. It is to be understood that the phraseology or terminology that is employed herein is for the purpose of description and not of limitation.

1. A method for manufacturing a water sports board (1, 2, 3) having a predetermined board shape, said method comprising the steps of
forming a core (10) including a shaped body (11) in a foam material, comprising the following components:
polylactic acid, and
a polymer selected from the group comprised of:
an aliphatic polyester;
an aliphatic/aromatic co-polyester;
a combination thereof;
externally covering said core (10) by a shell (20) of a composite material,
wherein said step of forming said core (10) comprises the steps of:
providing a semi-finished product (15, 16) selected between:
a pre-formed semifinished product (15) of said foam material, said pre-formed semifinished product (15) having a preliminary shape, and
a parallelepiped semi-finished product (16) of said foam material, said parallelepiped semifinished product (16) having the form of a parallelepiped block;
forming said semi-finished product (15, 16) into said shaped body (11), by hand working or machining, said step of forming including turning said preliminary shape or said parallelepiped shape into said board shape.

2. The method according to claim 1, wherein said polylactic acid is present by an amount set between 60% and 80% by weight, in particular by about 75% by weight, of said polymer component including an aliphatic polyester or an aliphatic/aromatic co-polyester.

3. The method according to claim 1, wherein said foam material is a polymer blend selected among the polymer blends known as Ecovio EA.

4. The method according to claim 1, wherein said foam material is a polymer blend known as Ecovio® EA200 or ECOVIO® 80EA2394EXP.

5. The method according to claim 1, wherein said step of forming a core includes a step of incorporating a cork longitudinal stringer (13) into said shaped body (11) of said core (10).

6. The method according to claim 1, wherein said step of forming a core includes a step of incorporating two cork longitudinal stringers (13) into said shaped body (11) of said core (10), said longitudinal stringers (13) spaced apart from each other by about half the cross width of said core (10).

7. The method according to claim 1, wherein said step of externally covering said core (10) by a shell (20) of a composite material comprises the steps of
covering said core (10) by a fibre layer (21, 24);
impregnating said fibre layer (21, 24) by a resin, before or after said step of covering said core (10) by a fibre layer (21, 24).

8. The method according to claim 7, wherein said step of impregnating said fibre layer (21, 24) by said resin is carried out in such a way that a portion of said resin forms a resin layer (23, 26) outside of said fibre layer (21, 24).

9. The method according to claim 7, wherein said fibre layer (23) comprises basalt fibres.

10. The method according to claim 7, wherein said step of externally covering said core (10) by a shell (20) comprises a step of covering said core (10) by a further fabric layer (22) and of impregnating said further fabric layer (22) with said resin before performing said step of covering said core (10) by a fibre layer (21, 24), so that said resin-impregnated further fabric layer (22) is arranged between said core (10) and said fibre layer (21) of said shell (20).

11. The method according to claim 1, including a step of providing an outer layer of a protective paint, in particular a polyurethane protective paint.

12. The method according to claim 1, wherein said polylactic acid is obtained by polymerization of lactic acid obtained by fermentation of destructured starch.

13. The method according to claim 1, wherein said step of providing a semi-finished product (15, 16) includes:
providing a plurality of core elements (17, 18) of said foam material;
connecting said core elements (17, 18) with one another onto and/or beside one another, until said preliminary or parallelepiped shape of said pre-formed (15) or parallelepiped (16) semifinished product, respectively, is obtained;
wherein said step of connecting said core elements comprises the steps of:
locally heating said core elements (17, 18) at respective mutual contact interfaces up to a predetermined connection temperature, and
pressing against one another said core elements (17, 18) arranged upon or beside one another until said core elements (17, 18) are connected together by thermal and pressure effect only, forming said semi-finished product (15, 16).

14. The method according to claim 13, wherein said core elements (17) have an elementary thickness (t) of at most 30 mm, in particular of at most 25 mm, and said semi-finished product (15, 16) has an overall thickness (T) set between 100 and 200 mm.

15. The method according to claim 13, wherein said core elements (18) have the shape of rectangular tiles having said elementary thickness.

16. The method according to claim 13, wherein said step of locally heating said core elements is carried out by directing to said contact interfaces a warm laminar air flow at a temperature set between 70° C. and 90° C.

17. The method according to claim 13, wherein said connection temperature is at most 80° C.

18. A water sports board structure (1, 2, 3) having a predetermined board shape, said sports board structure (1, 2, 3) comprising a core (10) and a shell (20) of composite material that externally covers said core (10), wherein said core (10) comprises a shaped body (11) made of a foam material,
characterized in that said foam material comprises the following components:
polylactic acid, and
a polymer selected from the group comprised of:
an aliphatic polyester;
an aliphatic/aromatic co-polyester;
a combination thereof,
wherein said core (10) is formed from a semi-finished product (15, 16) selected between:
a pre-formed semifinished product (15) having a preliminary shape, and
a parallelepiped semi-finished product (16) having the form of a parallelepiped block;
by hand working or machining, so as to turn said preliminary shape or said parallelepiped shape into said board shape.

19. The water sports board structure (1, 2, 3) according to claim 18, wherein the polylactic acid is present by an amount set between 60% and 80% by weight, in particular by about 75% by weight, of said polymer component including an aliphatic polyester or an aliphatic/aromatic co-polyester.

20. The water sports board structure (1, 2, 3) according to claim 18, wherein said foam material is a polymer blend selected among the polymer blends known as Ecovio EA.

21. The water sports board structure (1, 2, 3) according to claim 18, wherein said foam material is a polymer blend known as Ecovio® EA200 or ECOVIO® 80EA2394EXP.

22. The water sports board structure (3) according to claim 18, wherein said shaped body (11) incorporates a cork longitudinal stringer (13).

23. The water sports board structure (3) according to claim 18, wherein said shaped body (11) incorporates two cork longitudinal stringers (13) spaced apart from each other by about half the cross width of the core.

24. The water sports board structure (2, 3) according to claim 18, wherein said shell (20) comprises a fibre layer (21, 24) and a resin impregnating said fibre layer.

25. The water sports board structure (2, 3) according to claim 24, wherein a portion of said resin forms a resin layer (23, 26) outside of said fibre layer (21, 24).

26. The water sports board structure (2, 3) according to claim 24, wherein said fibre layer (23) comprises basalt fibres.

27. The water sports board structure (2, 3) according to claim 24, wherein said shell (20) comprises a further fabric layer (22) impregnated with said resin arranged between said core (10) and said fibre layer (21).

28. The water sports board structure (1, 2, 3) according to claim 18, wherein an outer layer of a protective paint is provided, in particular a polyurethane protective paint.

29. The water sports board structure (1, 2, 3) according to claim 18, wherein said polylactic acid is obtained by polymerization of lactic acid obtained by fermentation of destructured starch.

30. The water sports board structure according to claim 18, wherein said core (10) is formed by a plurality of core elements (17, 18) arranged upon and/or beside one another and thermally connected to one another at respective mutual interfaces.

31. The water sports board structure according to claim 30, wherein said core elements (17) have an elementary thickness (t) of at most 30 mm, in particular of at most 25 mm, and said core (10) has an overall thickness (T) set between 100 and 200 mm.

32. The water sports board structure according to claim 30, wherein said core elements (18) have the shape of rectangular tiles having said elementary thickness.
